(19) United States
(12) Patent Application Publication
(10) Pub. No.: US 2009/0092266 A1
(43) Pub. Date: Apr. 9, 2009

(54) Wireless audio system capable of receiving commands or voice input

(76) Inventors: Cheng-Chieh Wu, Tai-Nan City (TW); Jung-Hsin Yeah, Taoyuan County (TW); Chia-Hsin Lin, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/867,002

(22) Filed: Oct. 4, 2007

(51) Int. Cl. H04R 3/00

(52) U.S. Cl. 381/111

(57) ABSTRACT

A wireless audio system includes a host, a transmitter, and a receiver. The host includes a controller for controlling operations of the host, application software executed by the controller for producing audio signals, and a first electrical connector for connecting to a second electrical connector of the transmitter. The transmitter includes a first transceiver for wirelessly transmitting audio signals received from the host and for wirelessly transmitting and receiving data. The receiver includes a second transceiver for receiving audio signals wirelessly transmitted from the first transceiver of the transmitter, an audio output device for outputting the received audio signals, and a user interface for receiving a command from a user for controlling the host. The command is wirelessly transmitted from the receiver to the transmitter and delivered to the host, and the application software performs an action according to the command.

### BACKGROUND OF THE INVENTION

1. Field of the Invention

The present invention relates to a wireless audio system, and more particularly, to a wireless system having a host, a transmitter, and a receiver where the receiver is capable of receiving commands or voice input for delivery to the transmitter or the host.

2. Description of the Prior Art

Wireless audio systems offer users the ability to position audio equipment without having to worry about connecting each audio component with cables. A conventional wireless audio system includes a transmitter and a receiver. Please refer to FIG. 1, which illustrates a wireless audio system 1 according to the prior art. The wireless audio system 1 comprises a transmitter 2 and a receiver 4. The transmitter 2 receives audio input in the form of an audio signal from an audio source, and wirelessly transmits the input audio signal to the receiver 4. Upon receiving the audio signal, the receiver 4 outputs the audio signal to a device such as an amplifier, a speaker, or earphones.

The audio input may be from a variety of different sources, such as an MP3 player, a DVD player, a stereo, or a computer-based music player program. Taking a computer-based player program as an example, a common situation is that the player program has a list of songs to play in sequence or in random order. One main benefit of the wireless audio system 1 is that the user can listen to music near the receiver 4 instead of having to stay near the transmitter 2. However, at the present time, users near the receiver 4 do not have a way to control the audio source such as controlling the player program to pause, stop, advance to the next song, or go back to the previous song unless the users return to the transmitter 2 to control the audio source directly. Therefore, this limitation presents an inconvenience to users since the transmitter 2 may be located far away from the receiver 4 and users are left without a satisfactory way of controlling music playback through the receiver 4.

### SUMMARY OF THE INVENTION

It is therefore an objective of the claimed invention to provide an wireless audio system and related method, which has the capability of receiving commands or voice input through a wireless receiver for delivery to a transmitter or a host.

In order to accomplish the objective, the present invention provides a wireless audio system including a host, a transmitter, and a receiver. The host includes a controller for controlling operations of the host, application software executed by the controller for producing audio signals, and a first electrical connector for connecting to a second electrical connector of the transmitter. The transmitter includes a first transceiver for wirelessly transmitting audio signals received from the host and for wirelessly transmitting and receiving data. The receiver includes a second transceiver for receiving audio signals wirelessly transmitted from the first transceiver of the transmitter, an audio output device for outputting the received audio signals, and a user interface for receiving a command from a user for controlling the host. The command is wirelessly transmitted from the receiver to the transmitter and delivered to the host, and the application software performs an action according to the command.

The present invention also provides a method of wirelessly transmitting audio signals from a host to a receiver through a transmitter connected to the host. The method includes producing audio signals with application software of the host, sending the audio signals to the transmitter through a first electrical connector on the host coupled with a second electrical connector on the transmitter, wirelessly transmitting the audio signals from the transmitter to the receiver, and outputting the received audio signals through the receiver. The method also includes receiving a command from a user of the receiver for controlling the host, wirelessly transmitting the command from the receiver to the transmitter, sending the command from the transmitter to the application software of the host through the first and second electrical connectors, and the application software performing an action according to the command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a wireless audio system according to the prior art.

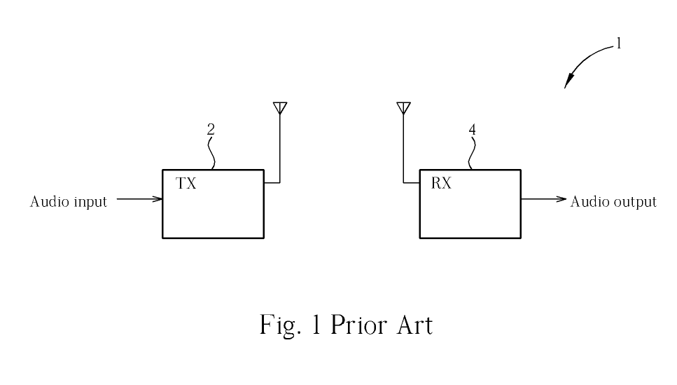

FIG. 2 is a functional block diagram of a wireless audio system according to a first embodiment of the present invention.

FIG. 3 is a functional block diagram of a wireless audio system according to a first embodiment of the present invention.

FIG. 4 is a diagram illustrating a network used for connecting a plurality of hosts to each other.

### DETAILED DESCRIPTION

The present invention offers a way for users located at a receiver side of a wireless audio system to control an audio source located at a transmitter side of the system.

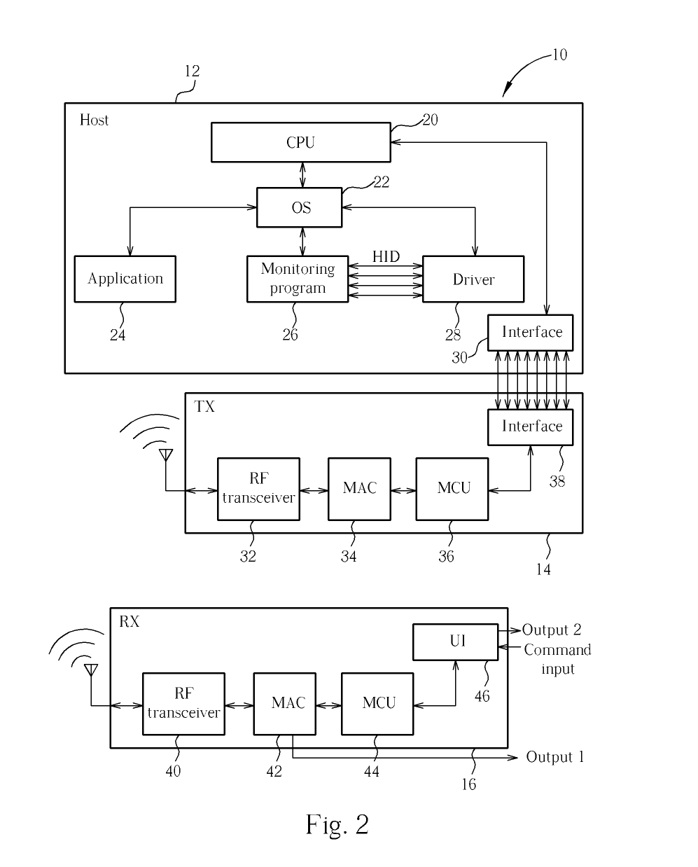

Please refer to FIG. 2. FIG. 2 is a functional block diagram of a wireless audio system 10 according to a first embodiment of the present invention. The wireless audio system 10 contains a host 12, a transmitter 14, and a receiver 16. The host 12 in this embodiment is a computer such as a PC, but is not limited to being a PC. The host 12 includes a central processing unit (CPU) 20 for controlling operations of the host 12, an operating system 22, and application software 24 installed on the host 12 for playing music or media files. Common examples of the application software 24 include Windows Media Player® or Winamp®, although the invention is not limited to these. The host 12 also includes an interface 30 such as a universal serial bus (USB) interface for allowing communication with the transmitter 14. A driver 28 is installed in the host 12 for enabling functionality of the interface 30. The driver 28 may be, for example, a standard USB driver. In addition, a human interface device (HID) monitoring program 26 is installed in the host 12 for monitoring received HID commands, as will be explained below.

The transmitter 14 contains an interface 38 for communicating with the interface 30 of the host 12. The transmitter 14 also comprises a radio frequency (RF) transceiver 32 for communicating wirelessly with the receiver 16, a media access control (MAC) device 34 for facilitating the wireless communication, and a microcontroller unit (MCU) 36 for controlling operation of the transmitter 14.

The receiver 16 includes an RF transceiver 40 for exchanging data with the RF transceiver 32 of the transmitter 14, a MAC device 42, an MCU 44, and a user interface 46. The MAC device 42 has a first output for outputting audio signals to devices such as an amplifier, a speaker, or an earphone jack. The user interface 46 has a second output for outputting information related to music playback on a display device such as a liquid crystal display (LCD) panel. In addition, the user interface 46 also receives commands input from a user. The user can input commands through devices such as a push button or a tact switch with tactile feedback for allowing the user to generate commands for controlling the host 12.

Operation of the wireless audio system 10 will be explained below. The application software 24 plays an audio file such as an MP3 file, WMV file, or MIDI file for producing audio signals. The audio signals are then output to the transmitter 14 through the interface 30 and the interface 38. The transmitter 14 then wirelessly transmits the received audio signals to the receiver 16 through the RF transceiver 32 and the RF transceiver 40. After the receiver 16 receives the audio signals, the audio data is output through the first output to the amplifier, speaker, or earphone jack.

While audio data is being sent from the host 12 to the receiver 16 via the transmitter 14, data related to the audio signals being played can also be sent from the host 12 to the receiver 16. For instance, related data such as the song name, artist, genre, remaining time of the song, etc., can be output from the application software 24, sent to the receiver 16, output through the second output via the user interface 46, and displayed on a display device connected to the second output. Other information that can be displayed includes linking status of the song being played (sync, lost sync) or the playing mode (random, repeat, single repeat) corresponding to the audio status.

Unlike the prior art, the wireless audio system 10 also provides a user with the ability to input commands through the user interface 46 of the receiver 16 for controlling the application software 24 of the host 12. When a command input through the user interface 46 (such as through pushing a button) is detected, the MCU 44 of the receiver 16 sends the command to the transmitter 14 through the RF transceiver 40 and the RF transceiver 32. The transmitter 14 then receives the command and sends the command to the host 12 through the interface 38 and the interface 30. The command then passes through the CPU 20 and the operating system 22 to the driver 28. The driver 28 passes the command on to the monitoring program 26 as an HID command. The monitoring program 26 identifies the input command from the user, and transfers the command to the operating system 22 for controlling the functionality of the application software 24. Thus, the user located at the receiver 16 is able to control the music playback of the application software 24 executed on the host 12 even though the user is not located near the host 12.

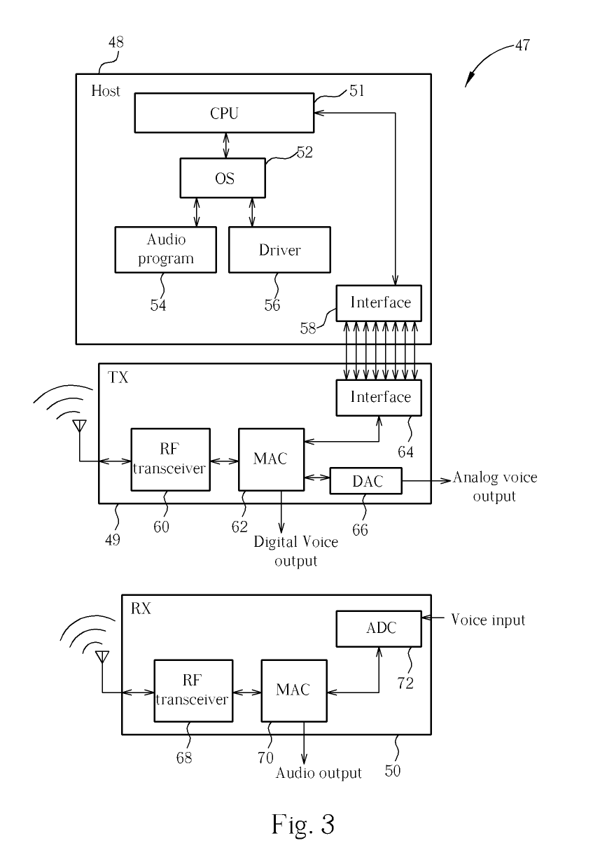

Please refer to FIG. 3. FIG. 3 is a functional block diagram of a wireless audio system 47 according to a first embodiment of the present invention. The wireless audio system 47 contains a host 48, a transmitter 49, and a receiver 50. Differing from the wireless audio system 10 shown in FIG. 2, the wireless audio system 47 allows a user to speak into the receiver 50 and transmit voice signals from the receiver 50 to the transmitter 49.

The host 48 in this embodiment can be a computer. The host 48 includes a central processing unit (CPU) 51 for controlling operations of the host 48, an operating system 52, and an audio program 54 for generating audio signals. The host 48 also includes an interface 58 such as a USB interface for allowing communication with the transmitter 49. A driver 56 is installed in the host 48 for enabling functionality of the interface 58.

The transmitter 49 contains an interface 64 for communicating with the interface 58 of the host 48. The transmitter 49 also comprises an RF transceiver 60 for communicating wirelessly with the receiver 50, a MAC device 62 for facilitating the wireless communication, and a digital-to-analog converter 66.

The receiver 50 includes an RF transceiver 68 for exchanging data with the RF transceiver 60 of the transmitter 49, a MAC device 70, and an analog-to-digital converter 72. The MAC device 70 has an audio output for outputting audio signals to devices such as an amplifier, a speaker, or an earphone jack. The analog-to-digital converter 72 has a voice input for receiving voice signals from the user of the receiver 50. The voice signals can be generated from a microphone connected to the voice input. The voice signals are then converted from analog format to digital format using the analog-to-digital converter 72 and transmitted to the transmitter 49 through the RF transceiver 68 and the RF transceiver 60. The transmitter 49 may output the voice signals through a digital voice output connected to the MAC 62 or through an analog voice output connected to the digital-to-analog converter 66. For the analog voice output, digital voice signals are first converted into analog form through the digital-to-analog converter 66 before being output through the analog voice output. The analog voice signals can be output through a speaker connected to the analog voice output.

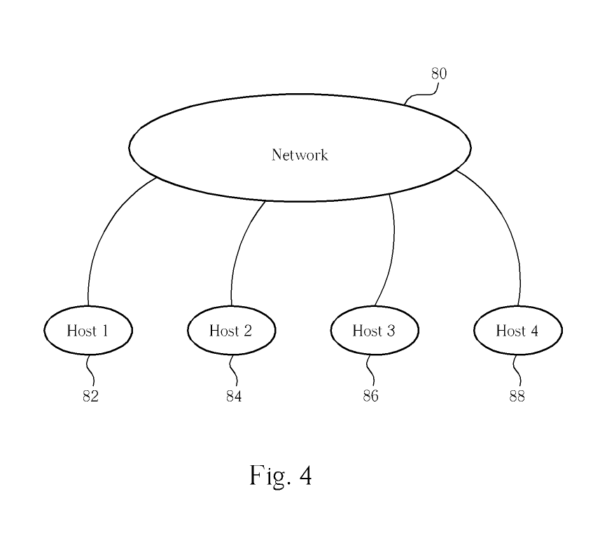

Please refer to FIG. 4. FIG. 4 is a diagram illustrating a network 80 used for connecting a plurality of hosts 82, 84, 86, 88 to each other. The network 80 can be a local area network (LAN), a wireless local area network (WLAN), or any similar type of network. The network 80 provides a way for a host connected to the network 80 to communicate with other hosts 82, 84, 86, 88 for exchanging data or information.

In the wireless audio system 10 of the first embodiment, a user of the receiver 16 can input commands to the receiver 16 for controlling the application software 24 running on the host 12. The wireless audio system 47 of the second embodiment allows the user to perform voice transmission for speaking into the receiver 50 and outputting voice signals from the transmitter 49. Thus, the present invention offers convenience to the user located near a receiver of a wireless audio system by allowing the user to perform more functions through the receiver instead of having to walk over to the host.

Those skilled in the art will readily observe that numerous modifications and alterations of the device and method may be made while retaining the teachings of the invention.

What is claimed is:

1. A wireless audio system, comprising:
a host, comprising:
a controller for controlling operations of the host;
application software executed by the controller for producing audio signals; and
a first electrical connector;
a transmitter, comprising:
a second electrical connector for connecting to the first electrical connector of the host, receiving audio signals from the host, and exchanging data with the host; and
a first transceiver for wirelessly transmitting the audio signals received from the host and for wirelessly transmitting and receiving data; and
a receiver, comprising:
a second transceiver for receiving audio signals wirelessly transmitted from the first transceiver of the transmitter;
an audio output device for outputting the received audio signals; and
a user interface for receiving a command from a user for controlling the host, wherein the command is wirelessly transmitted to the transmitter through the first and second transceivers, the transmitter sends the command to the application software of the host through the first and second electrical connectors, and the application software performs an action according to the command.

2. The system of claim 1, wherein the first and second electrical connectors are universal serial bus (USB) connectors.

3. The system of claim 1, wherein the audio output device is an amplifier.

4. The system of claim 1, wherein the audio output device is a speaker.

5. The system of claim 1, wherein the audio output device is an earphone jack.

6. The system of claim 1, wherein the user interface of the receiver comprises a display.

7. The system of claim 6, wherein while transmitting audio signals to the receiver through the transmitter, the application software also transmits related data that is shown on the display of the receiver.

8. The system of claim 1, wherein the user interface of the receiver comprises a push button or a tact switch with tactile feedback for allowing the user to generate commands for controlling the host.

9. The system of claim 1, wherein the receiver further comprises:
a microphone for receiving voice input from the user; and
an analog-to-digital converter for converting the voice input into digital voice signals for wirelessly transmitting the digital voice signals to the transmitter through the first and second transceivers; and
the transmitter further comprises:
a digital-to-analog converter for converting received digital voice signals into analog voice signals; and
a speaker for producing sound from the analog voice signals.

10. The system of claim 1, wherein the receiver further comprises:
a microphone for receiving voice input from the user; and
an analog-to-digital converter for converting the voice input into digital voice signals for wirelessly transmitting the digital voice signals to the transmitter through the first and second transceivers; and
the transmitter further comprises a digital audio output port for outputting the digital voice signals.

11. A wireless audio system, comprising:
a host, comprising:
a controller for controlling operations of the host; and
a first electrical connector;
a transmitter, comprising:
a second electrical connector for connecting to the first electrical connector of the host, receiving audio signals from the host, and exchanging data with the host;
a first transceiver for wirelessly transmitting the audio signals received from the host and for wirelessly transmitting and receiving data; and
a sound output device; and
a receiver, comprising:
a second transceiver for receiving audio signals wirelessly transmitted from the first transceiver of the transmitter;
an audio output device for outputting the received audio signals;
a microphone for receiving voice input from the user; and
an analog-to-digital converter for converting the voice input into digital voice signals for wirelessly transmitting the digital voice signals to the transmitter through the first and second transceivers for outputting the digital voice signals through the sound output device of the transmitter.

12. The system of claim 11, wherein the transmitter further comprises:
a digital-to-analog converter for converting received digital voice signals into analog voice signals; and
the sound output device is a speaker for producing sound from the analog voice signals.

13. The system of claim 11, wherein the sound output device of the transmitter is a digital audio output port for outputting the digital voice signals.
